(19) United States
(12) Patent Application Publication
(10) Pub. No.: US 2002/0138935 A1
(43) Pub. Date: Oct. 3, 2002

(54) Paint roller cage

(76) Inventor: Donald D. Lanz, Oregon City, OR (US)

Correspondence Address: MARK D. OLSON, OLSON-OLSON, 2400 S.W. 4th Avenue, Portland, OR, 97201, US

(21) Appl. No.: 10/108,137

(22) Filed: Mar. 26, 2002

Related U.S. Application Data
(60) Provisional application No. 60/279,633, filed on Mar. 29, 2001.

(51) Int. Cl. B05C 17/02

(52) U.S. Cl. 15/230.11; 492/13; 492/19

(57) ABSTRACT

A paint roller cage body is provided to support the length of a paint roller cover in substantially entirely untensioned engagement except at a single predetermined point located on the cage framework at a predetermined axially outwardly spaced distance from the inner end cap member of the cage body, at which point radial projections on the cage framework frictionally and tensionably engage the inner surface of a roller cover core to secure it releasably on the roller cage during painting operations and permit axial sliding of a roller cover under tensioned engagement for the distance required for the cover to clear tensioned engagement under the impact force of a single downward rap of a paint roller against the rim of a paint bucket, the cover then free to simply slide by gravity off of the remaining length of the roller cage and into the bucket whereby to avoid paint splatter and other inconveniences during removal of a roller cover after painting operations.

This application claims the benefit under 35 U.S.C. 119(e) of U.S. Provisional application Ser. No. 60/279,633, Filed Mar. 29, 2001.

### BACKGROUND OF THE INVENTION

This invention relates to paint rollers and more particularly to a paint roller cage arranged to releasably secure a roller cover for use thereon during painting and in particular allows the roller cover to be quickly and easily removed from the cage without need of physical grasping of and pulling on the paint-laden cover after use.

As is known by painters and others familiar with paint rollers, paint roller cages have commonly been provided heretofore with various structures arranged to frictionally engage the core of a roller cover substantially evenly along its length, whereby to secure the cover positively to the cage for rotation therewith on the bearing surfaces of the latter and against inadvertent and undesirable creeping movement of the cover longitudinally along the cage during painting operations. While these arrangements are entirely adequate for the purpose of keeping the cover on the paint roller cage during use, they pose an inconvenience to the operator after the painting operation when the cover needs to be removed from the paint roller for cleaning.

With frictional, tensional contact of the cover core along substantially the entire length of the cage, the cover must be physically moved along the entire length of the cage against that frictional contact in the removal of the cover. The less than desirable aspects of grasping and pulling on a paint-saturated paint roller cover are quite apparent. Another method of removing roller covers that is preferred by painters is to sharply rap the paint roller frame against the edge of a paint bucket so that the impact effectively drives the cover along and off the cage, whereupon the cover drops into the paint bucket. Again, with frictional contact between the cover and the cage being maintained virtually along the entire length of the cage, numerous such raps are typically required to free the cover from the supporting cage, and with a paint-laden cover, the potential for paint spatter and drips during the impacting operation clearly increases.

U.S. Pat. No. 5,490,303 (Graves) is the only prior art that has been found that specifically addresses this issue, but Graves does so by the provision of a specialized cage construction that utilizes a specially-configured inner end cap arranged to mount a unique Belleville type spring arranged to tensionably engage an end portion of the core of a cover member about the circumference of the inner end cap. This arrangement clearly requires not only the provision of the specialized inner end cap member and the specialized spring that is required, but it also requires the additional labor intensive assembly of these parts during manufacture of the roller cage. Further, the resulting cage construction is limited to the provision of tension engagement of the roller cover only adjacent its terminal-most, open end over the inner end cap. As will be understood, the open terminal ends of a tube member such as the core of a roller cover is the structurally weakest portion of a tube, and therefore this point of engagement of the cover core is more susceptible to expansion under the tension of the spring, thereby reducing the strength of the tension engagement provided by the Belleville type spring, and also increasing the likelihood of eventual wearing and stretching of the core end which could prematurely render the roller cover unengageable by the cage tension apparatus of Graves and unable to satisfactorily secure the roller cover on the cage during use of the roller in painting operations. Also, experience in the marketplace has revealed that the many pockets, recesses and spring fingers of the Graves paint roller construction provide a multitude of “paint traps” that require careful and concerted cleaning to assure against the build-up of dried paint around and beneath the fingers of the Belleville spring which necessarily results in the loss of the spring action of the fingers and their ability to properly engage the core of a roller cover.

### SUMMARY OF THE INVENTION

In its basic concept this invention provides a paint roller cage apparatus which is arranged to tensionably engage a roller cover core only at a single circumferential point about the longitudinally extending framework portion of the roller cage spaced outwardly a predetermined distance thereon from the inner end cap member of the cage.

It is by virtue of the foregoing basic concept that the principal objective of this invention is achieved; mainly, the provision of a paint roller cage that allows the easy and simplified removal of a paint roller cover member while also assuring its satisfactory securement on the cage during operation of the paint roller in painting, and thereby provide a paint roller cage construction that overcomes the disadvantages and limitations of paint roller cage constructions of the prior art.

Another object and advantage of this invention is the provision of a paint roller cage apparatus of the class described which tensionably engages the core of a paint roller cover inwardly of its open terminal ends and thereby utilize the stronger portions of the roller cover core for tensioned engagement with the cage member.

Another objective and advantage of the present invention is the provision of a paint roller cage of the class described which requires no additional manufacturing or assembly steps over standard, basic cage constructions of the prior art.

Yet another object and advantage of this invention is the provision of a paint roller cage of the class described which is easy to clean after painting operations and provides no structures which form “paint traps” that require special cleaning attention or which can adversely affect the cover-engaging operation of the roller cage.

A further object and advantage of this invention is the provision of a paint roller cage of the class described which is of simplified construction for economical manufacture and reliability of use.

The foregoing and other objects and advantages of this invention will appear from the following detailed description taken in connection with the accompanying drawings of preferred embodiments.

### BRIEF DESCRIPTION OF THE DRAWINGS

FIG. 1 is a plan view of a wire paint roller cage embodying the features of this invention.

FIG. 2 is a fragmentary, foreshortened sectional view of the wire paint roller cage of FIG. 1 showing a roller cover thereon in an initial, incomplete condition of installation.

FIG. 3 is a fragmentary, foreshortened sectional view similar to FIG. 2 but showing a roller cover in a fully installed condition on the roller cage.

FIG. 4 is a fragmentary perspective view of the inner end portion of another embodiment of a paint roller cage of this invention formed of a plastic rib construction in accordance with this invention.

### DESCRIPTION OF THE PREFERRED EMBODIMENTS

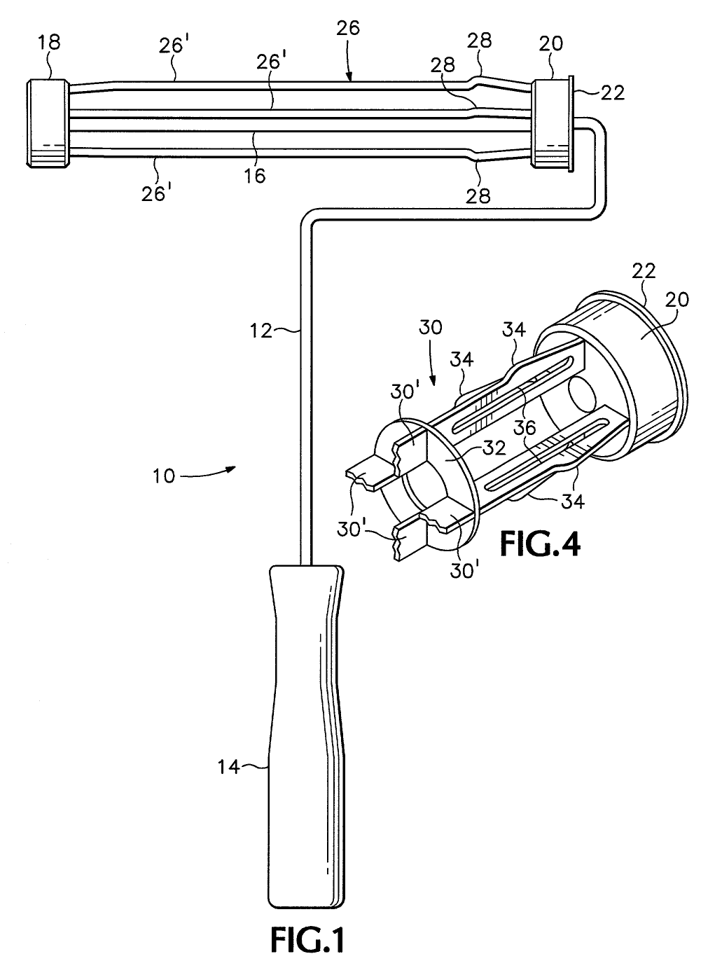

Referring to FIG. 1, a paint roller 10 comprises a frame member 12 which mounts a handle member 14, the frame member having a roller cage-mounting support rod 16 as is well known. The support rod 16 receives, captures and supports a paint roller cage for rotation of the cage thereon during the rolling operation of the paint roller as is well understood in the art.

Not unlike paint roller cages of the prior art, the paint roller cage of this invention comprises a first, outer end cap 18 and a second, inner end cap 20, the inner end cap 20 including an enlarged stop end portion 22 configured to provide an abutment stop for the terminal end of a roller cover 24 installed fully onto the cage as is well known in the art. The end caps 18, 20 include central bores (not shown) therethrough which provide axle bearing support surfaces for rotatably supporting the cage on the support rod 16 as is known in the art.

Spanning between the first and second end caps 18, 20 is a generally cylindrical, longitudinally extending framework portion 26, here provided as a plurality of annularly-spaced apart longitudinally-elongated wire rods 26′ fixedly captured at their opposite ends by the first and second end cap members 18, 20. The wire rods of roller cages provided heretofore have typically been configured to provide a longitudinally extending framework having an external diameter greater than the internal diameter of the core 24′ of a roller cover 24 so that the wire rods engage the core in spring-tensioned, frictional engagement along substantially the entire mutually contacting length of the core 24′ and rods, whereby to positively engage and secure the roller cover on the cage against undesirable axial movement during use, while still permitting the cover to be manually pushed or driven axially onto and off of the cage.

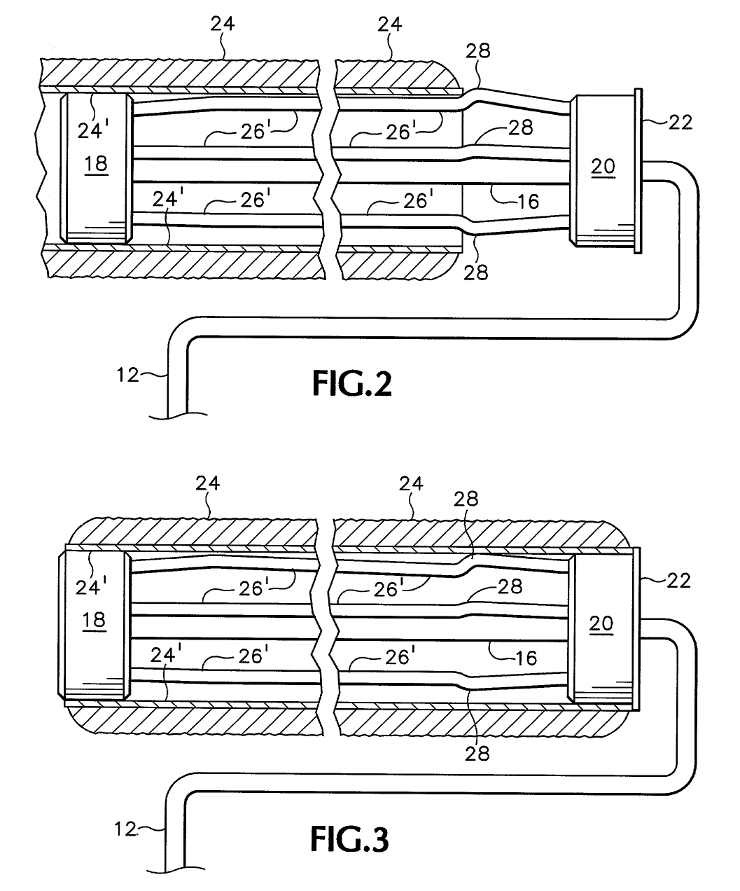

In the wire roller cage construction of this invention, as illustrated in the embodiment of FIGS. 1, 2 and 3 of the drawings, the end caps and longitudinally-extending wire rod framework 26 of the cage are configured to provide a cage body having an external diameter that is substantially equal to or slightly less than the internal diameter of a cover core 24′ (FIG. 2) for the length of the framework extending from the first, outer end cap 18 to a point located at a predetermined distance spaced outwardly from the connecton of the wire rod framework 26 to the second, inner end cap 20. At this said outwardly-spaced point, at least one, and preferably all of the wire rods 26′ forming the framework 26 are configured, as by the outwardly projecting bend 28 arrangement illustrated, to provide the framework 26 with an enlarged external diameter band only at that said outwardly-spaced circumferential point on the framework.

This construction provides for a roller cover-supporting, but substantially untensioned engagement between the framework 26 and caps 18, 20, and the core 24′ of a roller cover 24 over substantially the entire length of the cage body except at said outwardly spaced point of enlarged framework diameter (28) where, as clearly illustrated in viewing FIGS. 2 and 3, spring-tensioned interengagement of the roller cover core 24′ and framework is provided. This single band of tensioned, frictional interengagement provides roller cover-securing tension means sufficient to secure the cover onto the cage against axial movement of the cover along the cage during use of the paint roller in painting operations. Even though there is substantially no tensioned, frictional engagement between the cover and the rest of the cage framework to restrict axial movement of the cover therealong, the relatively close, but non-frictional diametric tolerances between a roller cover core and the framework still provide full support of the cover by the framework during use of the paint roller in its paint-rolling operation.

Therefore, as will be apparent to those skilled in the art, the cage framework and end caps together form a cage body that supports an installed roller cover along its entire length for painting operations but provides means for tensioned, holding interengagement between the framework and cover only at the single circumferential band of enlarged framework diameter 28 provided a spaced distance outwardly from the inner end cap 20. In this manner, with the paint roller oriented with its outer end cap 18 pointing downwardly into an empty paint bucket, a single, forceful downward rap of the roller frame 12 against the edge of the paint bucket provides sufficient impact force to cause the cover to overcome the spring tension provided by outward bends 28 of the framework and travel axially along the framework for the predetermined distance required for the cover to clear its tensioned engagement with bends 28. At this point, since the remaining length of the framework 26 is configured with a diameter that provides for untensioned engagement with the core of a roller cover, the cover is free to simply slide off of the cage freely by gravity without need for any additional raps of the roller frame against the edge of the paint bucket. Thus, there is no need for unnecessarily forceful or repeated impacts to free a roller cover as is necessary with prior art roller assemblies. Further, as clearly seen in FIG. 1 of the drawings, with the cover removed from the roller cage, the cage has no structure which can form “paint traps” requiring any cleaning effort over that required of conventional wire cage constructions long known in the art.

The same principle that has been described above is used in the plastic roller cage construction embodied in FIG. 4 of the drawings. In this embodiment of the invention, the longitudinally elongated framework 30 is formed of annularly-spaced, longitudinally-elongated plastic rib members 30′ preferably provided with reinforcing members 32 spaced apart longitudinally along the cage to strengthen and rigidify the ribs and assure the uniformity of the external diameter of the framework along its length. In conventional manner, the terminal ends of the individual plastic rib members are secured to opposite end caps 18, 20 as will be understood.

In this embodiment of the invention, the enlarged diameter portion of the framework (provided by bends 28 in the earlier embodiment), is similarly provided as a widened portion of the rib members forming outward projections 34 on the outer edge surface of at least one, and preferably all of the ribs 30′ forming the framework portion 30. In order to provide sufficient resiliency to the widened portions of the rib members to permit the projections 34 to engage the core of a cover in substantially spring tensioned engagement, tension relief slots 36 are preferably included in the rib formation as shown. In this manner, when a cover is installed onto the cage over the outward prjections 34, the projecting portions will be allowed to deflect inward somewhat in order to reduce resulting strain on the framework while also maintaining the desired tensioned contact with the core of the cover. The cover removal process for this embodiment of the roller cage of my invention clearly is the same as described in connection with the wire cage embodiment of FIGS. 1-3.

It is to be understood that the distance from the inner end cap 20 that the enlarged diameter 28, 34 of the framework 26, 30 is to be formed is predetermined and selected to provide a desired length of axial travel in which a cover will be retained in tensioned, frictional engagement with the cage before that tensioned, frictional interengagement is released. For this reason, the enlarged diameter of the cage is preferably located on the framework a spaced distance outwardly from the inner end cap member that is calculated to permit release of the roller cover under the impact of a single sharp rap of the paint roller frame downwardly against the edge of a paint bucket.

From the foregoing it will be apparent to those skilled in the art that other types of paint roller cage constructions, different from the rod and rib member constructions illustrated herein, may be utilized in the construction of the cage of this invention to provide the required reduced diameter framework portion and enlarged diameter circumferential framework point taught herein. Similarly, it will also be apparent to those skilled in the art that various other changes may be made in the size, shape, type, number and arrangement of parts described hereinbefore without departing from the spirit of this invention, and the scope of the appended claims.

Having this described my invention and the manner in which it may be used, I claim:

1. A paint roller cage for releasably supporting a roller cover rotatably on a paint roller frame for painting operations and for facilitated removal of a roller cover after painting operation, the paint roller cage comprising:
a) a roller cage body having a longitudinally elongated framework portion mounting at it its opposite longitudinal terminal ends a pair of opposite, inner and outer cage end cap members configured with axle bearing support means for rotatably securing the cage body to the support rod member of a paint roller frame, said roller cage body providing a longitudinally elongated, generally cylindrical roller cover support member having an overall external diameter configured to support substantially the entire length of an installed roller cover thereon in substantially entirely untensioned engagement along substantially its entire length, and
b) roller cover-securing tension means on said elongated framework portion intermediate said opposite end cap member-mounting opposite terminal ends for frictionally and tensionably engaging the core of a roller cover installed on the roller cage only at a single circumferential point located at a predetermined distance spaced axially outwardly from the terminal end of said framework portion mounting said inner end cap member.

2. The paint roller cage of claim 1 wherein said predetermined distance spaced axially outwardly from the terminal end of said framework portion is predetermined to permit axial sliding movement of a roller cover member under tensioned engagement of said tension means for that distance sufficient for a roller cover to clear said tensioned engagement under the impact force provided by a single, predetermined downward impact of a paint roller frame upon a fixed surface, a roller cover then free to slide off the remaining length of the outer portion of the roller cage body by gravity.

3. The paint roller cage of claim 1 wherein said framework portion comprises a plurality of longitudinally extending rib members fixedly secured at their opposite terminal ends to respective inner and outer end cap members, and said roller cover-securing tension means comprises a radially outwardly extending projection formed on at least one of said plurality of rib members to increase the overall external diameter of the framework portion at said predetermined distance spaced axially outwardly from the terminal end of said framework portion mounting said inner end cap member.

4. The paint roller cage of claim 3 wherein each said plurality of rib members is configured with said radially outwardly extending projection and together forming a circumferential ring of enlarged framework diameter at said predetermined distance spaced axially outwardly from the terminal end of said framework portion mounting said inner end cap member.

5. The paint roller cage of claim 1 wherein said framework portion comprises a plurality of longitudinally extending wire rods fixedly secured at their opposite terminal ends to respective inner and outer end cap members, and said roller cover-securing tension means comprises a radially outwardly extending bend formed in at least one of said plurality of wire rods to increase the overall external diameter of the framework portion at said predetermined distance spaced outwardly from the terminal end of said framework portion mounting said inner end cap member.

6. The paint roller cage of claim 5 wherein each said plurality of wire rods is configured with said radially outwardly projecting bend together forming a circumferential ring of enlarged framework diameter at said predetermined distance spaced axially outwardly from the terminal end of said framework portion mounting said inner end cap member.
